(19) United States
(12) Patent Application Publication
(10) Pub. No.: US 2018/0321763 A1
(43) Pub. Date: Nov. 8, 2018

(54) TOUCH SUBSTRATE AND FABRICATION METHOD THEREOF, AND DISPLAY DEVICE

(71) Applicant: BOE TECHNOLOGY GROUP CO., LTD., Beijing (CN)

(72) Inventors: Guodong Liu, Beijing (CN); Ming Hu, Beijing (CN); Ming Zhang, Beijing (CN); Jun Xu, Beijing (CN)

(73) Assignees: BOE TECHNOLOGY GROUP CO., LTD., Beijing (CN); HEFEI XINSHENG OPTOELECTRONICS TECHNOLOGY CO., LTD., Hefei, Anhui (CN)

(21) Appl. No.: 15/741,749

(22) PCT Filed: Jun. 26, 2017
(86) PCT No.: PCT/CN2017/089947

§ 371 Date: Jan. 3, 2018

(30) Foreign Application Priority Data
Jul. 26, 2016 (CN) 201610599624.9

(51) Int. Cl. G06F 3/044; G06F 3/047

(52) U.S. Cl. CPC G06F 3/044; G06F 3/047; G02F 2201/121; G06F 2203/04104; G06F 2203/04103; G06F 2203/04111; G06F 2203/04112

(57) ABSTRACT

Touch substrate and fabrication method, and display device are provided. The touch substrate includes a transparent substrate: and a first electrode layer, an insulating layer, and a second electrode layer, sequentially on the transparent substrate. The first electrode layer includes a plurality of first electrodes. The second electrode layer includes a plurality of second electrodes. The first electrodes intersect with the second electrodes. Each of the first electrodes and the second electrodes has a mesh structure.

### CROSS-REFERENCES TO RELATED APPLICATIONS

This application claims the priority of Chinese patent application No. 201610599624.9, filed on Jul. 26, 2016, the entirety of which is incorporated herein by reference.

### FIELD OF THE DISCLOSURE

The present disclosure generally relates to the field of touch control technology and, more particularly, relates to a touch substrate, a fabrication method of the touch substrate, and a display device containing the touch substrate.

### BACKGROUND

With rapid development of display technology, touch screen has been widely used in smart phones, tablet PCs, television and other electronic products. A capacitive touch screen has advantages including precise positioning sensitivity, desired touch feeling, long service life, etc. The capacitive touch screen has drawn more and more attention. The touch screen may include self-capacitance touch screen and mutual-capacitance touch screen due to the touch mode. Because the mutual-capacitance touch screen can achieve multi-touch, it has become the mainstream and trend of future development in the current touch screen market.

One glass solution (OGS) refers to directly forming touch electrodes made of indium tin oxide (ITO) and a bridge made of ITO or a metal on a protection glass. The protection glass can provide a dual role including protection and touch control at the same time.

A touch structure in a conventional OGS touch screen includes a first touch electrode and a second touch electrode that intersects with one another and are isolated by a bridge crossing and above the first touch electrode. Therefore, a fabrication process to form the touch structure includes at least three patterning processes. A greater number of the patterning processes results in an increase in production costs.

In addition, breakdown at the bridge during the electrostatic discharge (ESD) process may easily occur, thus the performance of products may be affected.

### BRIEF SUMMARY OF THE DISCLOSURE

Touch substrate, fabrication method, and display device are provided in accordance with various disclosed embodiments in the present disclosure.

One aspect of the present disclosure includes a touch substrate. The touch substrate includes a transparent substrate; and a first electrode layer, an insulating layer, and a second electrode layer, sequentially on the transparent substrate. The first electrode layer includes a plurality of first electrodes. The second electrode layer includes a plurality of second electrodes. The first electrodes intersect with the second electrodes. Each of the first electrodes and the second electrodes has a mesh structure.

Optionally, the first electrode is a sensing electrode, the second electrode is a driving electrode, and the first electrodes and the second electrodes are made of a metal material.

Optionally, a square resistance of the metal material is smaller than or equal to 0.3 Ω/cm².

Optionally, the touch substrate further includes a protection layer above the second electrode layer.

Optionally, the protection layer is made of a same material as the insulating layer.

Optionally, a shape of a mesh in the mesh structure is a regular polygon.

Optionally, the insulating layer is made of an inorganic material including at least one of silicon oxide, silicon nitride, and silicon oxynitride.

Optionally, the insulating layer is between the first electrodes and the second electrodes in a direction perpendicular to a surface of the transparent substrate.

Optionally, the first electrodes and the second electrodes are made of Ag (silver), Cu (copper), Al (aluminum), or AlNb (aluminum niobium alloy) alloy.

Another aspect of the present disclosure includes a display device. The display device includes a display panel; and the disclosed touch substrate on a light exit side of the display panel.

Optionally, the display panel is a liquid crystal display panel; or the display panel is an organic light emitting diode (OLED) display panel.

Optionally, the display panel is attached to the touch substrate through an optical adhesive.

Another aspect of the present disclosure includes a fabrication method of a touch substrate by forming a first electrode layer, on a transparent substrate and including a plurality of first electrodes each having a first mesh structure: forming an insulting layer on the first electrode layer; and forming a second electrode layer, on the insulating layer and including a plurality of second electrodes each having a second mesh structure. Orthographic projections of the first electrodes and the second electrodes on the transparent substrate intersect with one another.

Optionally, one of the first electrode and the second electrode is a driving electrode, and another of the first electrode and the second electrode is a sensing electrode.

Optionally, the fabrication method further includes forming a protection layer, above the second electrode layer.

Optionally, the protection layer is made of a same material as the insulating layer.

Optionally, a shape of a mesh in the first and second mesh structures is a regular polygon.

Optionally, the first electrode layer and the second electrode layer are formed by a patterning process, including film formation, exposure, development, etching, and photoresist peeling.

Optionally, the first electrode layer and the second electrode layer are formed by a printing process or a typography process.

Optionally, the insulating layer is formed by a deposition process or a coating process,

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic of a conventional touch structure;

FIG. 2 illustrates a schematic top view of an exemplary touch substrate consistent with disclosed embodiments;

FIG. 3 illustrates a schematic cross-sectional view of the touch substrate along A-A1-A2-A3-A4-A′ shown in FIG. 2;

FIG. 4 illustrates a schematic cross-sectional view of the touch substrate along B-B′ shown in FIG. 2;

FIG. 5 illustrates another schematic cross-sectional view of the touch substrate along B-B′ shown in FIG. 2;

FIG. 6 illustrates a schematic of a shape of a mesh in sensing electrodes consistent with disclosed embodiments;

FIG. 7 illustrates a schematic of an exemplary display device consistent with disclosed embodiments;

FIG. 8(a) illustrates a flow chart of an exemplary fabrication method of a touch substrate consistent with disclosed embodiments;

FIG. 8(b) illustrates a flow chart of another exemplary fabrication method of a touch substrate consistent with disclosed embodiments; and

FIG. 8(c) illustrates a flow chart of another exemplary fabrication method of a touch substrate consistent with disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

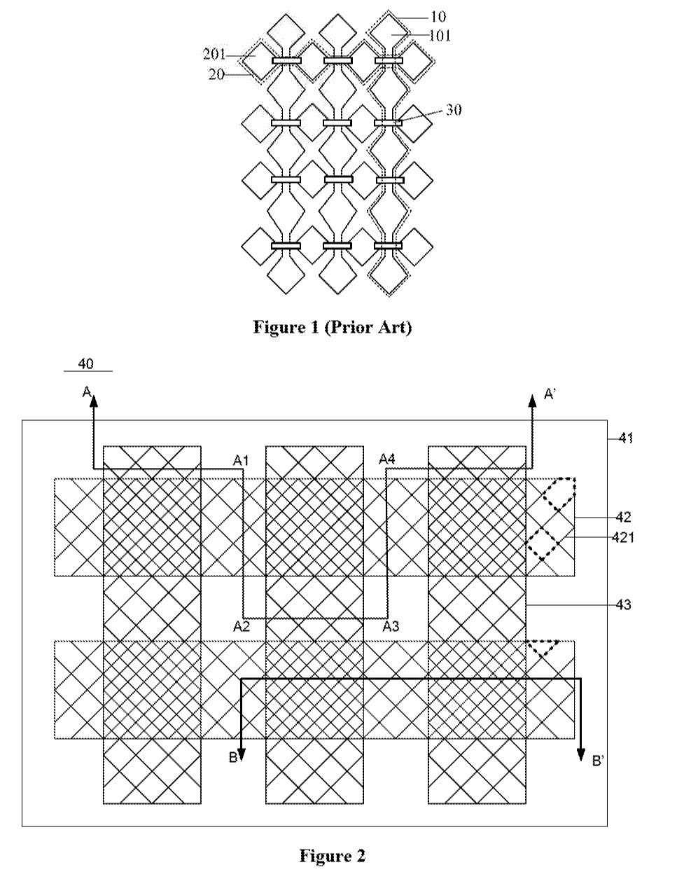

FIG. 1 illustrates a touch structure in a conventional one glass solution (OGS) touch screen. Referring to FIG. 1, the touch structure includes a first touch electrode 10 and a second touch electrode 20 that intersect with one another. The first touch electrode 10 includes a plurality of first touch sub-electrodes 101 that are directly connected, and the second touch electrode 20 includes a plurality of second touch sub-electrodes 201 that are connected by a bridge 30. Therefore, a fabrication process to form the first touch electrode 10 and the second touch electrode 20 includes at least three patterning processes. A greater number of the patterning processes results in an increase in production costs.

In addition, because the second touch sub-electrodes 201 are connected by the bridge 30, breakdown at the bridge during the electrostatic discharge (ESD) process may easily occur, thus the performance of products may be affected.

The present disclosure provides a touch substrate. Referring to FIGS. 2-4, a touch substrate 40 may include a transparent substrate 41, a sensing electrode layer and a driving electrode layer on the transparent substrate 41. The sensing electrode layer and the driving electrode layer are isolated by an insulating layer 44. The sensing electrode layer may include a plurality of sensing electrodes 42, and the driving electrode layer may include a plurality of driving electrodes 43. The sensing electrodes 42 may intersect with the driving electrodes 43. Each of the sensing electrodes and the driving electrodes may have a mesh structure.

The material of the sensing electrode layer and the driving electrode layer is not limited, and may be a transparent conductive material, such as ITO, or a metal material. The insulating layer 44 may be made of an inorganic material, including SiO₂ (silicon oxide). SiₓN_{y}(silicon nitride), SiOₓN_{y} (silicon oxynitride) and other inorganic transparent materials, or an organic material, such as organic material configured as an over coating (OC) layer and other organic materials with high transmittance. Each sensing electrode 42 may have a mesh structure, in other words, each sensing electrode 42 may include a plurality of wires, and the plurality of wires may intersect with each other to form a plurality of meshes. Similarly, each driving electrode 43 may also include a plurality of wires, and the plurality of wires may intersect with each other to form a plurality of meshes. The transparent substrate 41 may be a glass substrate.

In the touch substrate 40 provided in the present disclosure, by forming the sensing electrode layer and the driving electrode layer on the transparent substrate 41, the insulating layer 44 for isolation may be formed without being etched, therefore the fabrication process of the sensing electrode layer and the driving electrode layer may be completed by at most two patterning processes. Compared to the existing techniques, the number of the patterning processes may be reduced, the fabrication process may be simple and high yield. On this basis, because the sensing electrodes 42 and the driving electrodes 43 have a mesh structure and are directly formed on the transparent substrate 41, transmittance of the touch substrate 40 may be increased and reach approximately 90% or more. In addition, compared to the existing techniques, because there is no bridge, the breakdown phenomenon at the bridge during the ESD process may be avoided, thus the performance of the products may be improved.

The sensing electrodes 42 and the driving electrodes 43 may be made of a metal material. The metal material may be a metal element or alloy. Because a square resistance of the metal material is small, even if the touch substrate 40 provided in the present disclosure is applied to a large-size or an ultra-large-size touch screen, the touch substrate 40 can be driven by an integrated circuit (IC), can achieve desired touch effect, and can support multi-touch. In addition, the material process cost can be significantly reduced by selecting a conventional metal material.

The square resistance of the metal material may be smaller than or equal to 0.3 Ω/cm². For example, the metal material may be Ag (silver), Cu (copper), Al (aluminum), or AlNb (aluminum niobium alloy) alloy. etc.

In one embodiment., the sensing electrodes 42 and the driving electrodes 43 may be fanned by using a metal material having excellent electrical conductivity, thus the touch substrate 40 can achieve excellent touch effect and support up unlimited-point touch. The square resistance of the metal material may be smaller than or equal to 0.1Ω/cm ².

Based on this, referring to FIG. 5, the touch substrate 40 may also include a protection layer 45. The protection layer 45 may be formed above one of the sensing electrode layer and the driving electrode layer, which is further away from the transparent substrate 41. In one embodiment, referring to FIG. 5, the sensing electrodes 42 may be first fabricated and formed on the transparent substrate 41, and then the driving electrodes 43 may be fabricated and formed. Thus, the protection layer 45 may be formed above the driving electrodes 43. In another embodiment, the driving electrodes 43 may be first fabricated and formed on the transparent substrate 41, and then the sensing electrodes 42 may be fabricated and formed. Thus, the protection layer 45 may be formed above the sensing electrodes 42.

In the present disclosure, by providing the protection layer 45 above one of the sensing electrode layer and the driving electrode layer, that is further away from the transparent substrate 41, when the sensing electrode layer or the driving electrode layer, that is formed on the outermost side, is made of a metal material, reduction in the touch performance caused by oxidation and corrosion may be avoided.

The protection layer 45 may be made of a same material as the insulating layer 44. In the present disclosure, by forming the protection layer 45 with the same material as the insulating layer 44, the material cost may be saved and the process may be simpler.

Based on this, a shape of a mesh in the mesh structure may be a regular polygon or an irregular polygon. In other words, referring to FIG. 2, using one sensing electrode 42 as an example, all the wires (for example, the metal wires 421) may intersect with each other to form a plurality of meshes, the shape of any one mesh may be a regular polygon or an irregular polygon. Referring to dashed boxes in FIG. 2, the shape of the mesh may be rhombic, triangular, or pentagonal, etc. Referring to a dashed box in FIG. 6, the shape of the mesh may be rectangular. In addition, the shape of the mesh may he hexagonal or other regular polygons, or irregular polygons, etc.

For the touch substrate 40 to be applied to the display device with any size, before fabricating the sensing electrodes 42 and the driving electrodes 43 that have the mesh structure, optical simulation may be first performed by using a related software, such that, the parameters of the mesh of the sensing electrodes 42 and the driving electrodes 43 may match with the display panel. For example, for a diamond-shaped mesh, appropriate diamond side length and diamond angle may be simulated to avoid an issue of easy occurrence of interference fringes after the mismatched touch substrate 40 is fitted to the display panel.

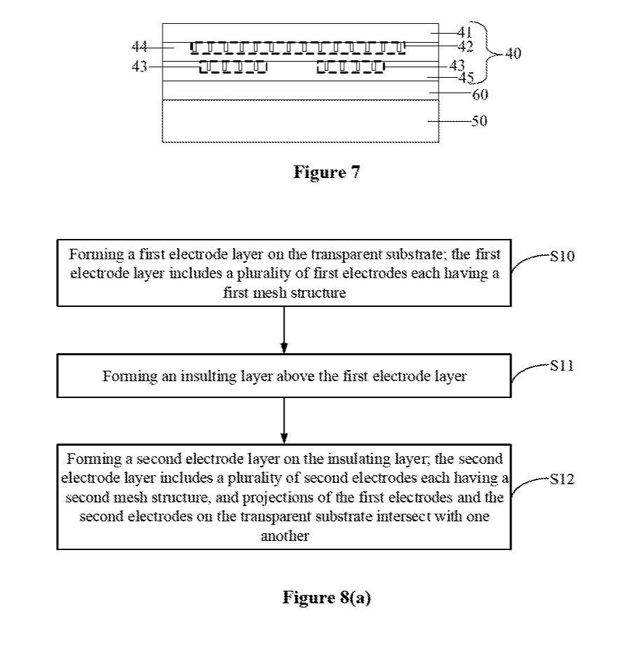

The present disclosure also provides a display device. Referring to FIG. 7, the display device may include the touch substrate 40 provided on a light exit side of the display device. For example, the display device may be a display, a television, a digital photo frame, a mobile phone, a tablet, or other any product or component having a display touch function.

Referring to FIG. 7, the display device may also include a display panel 50. The touch substrate 40 may be provided on a light exit side of the display panel 50. The display panel 50 may be a liquid crystal display panel or an organic light emitting diode (OLED) display panel. The display panel 50 and the touch substrate 40 may be connected through an optically clear resin (OCR) 60.

When the display panel 50 is the liquid crystal display panel, the display panel 50 may include an array substrate, a cassette substrate, and a liquid crystal layer disposed there-between. In one embodiment, the array substrate may include a thin film transistor (TFT), and a pixel electrode electrically connected to a drain of the TFT. In certain embodiments, the array substrate may also include a common electrode. The cassette substrate may include a black matrix and a color film. The color film may be provided on the cassette substrate, or may be provided on the array substrate; the common electrode may be provided on the array substrate, or may be provided on the cassette substrate.

When the display panel 50 is the OLED display panel, the display panel 50 may include an array substrate and a package substrate. The array substrate may include a TFT, an anode electrically connected to a drain of the TFT, a cathode, and an organic material functional layer formed between the anode and the cathode.

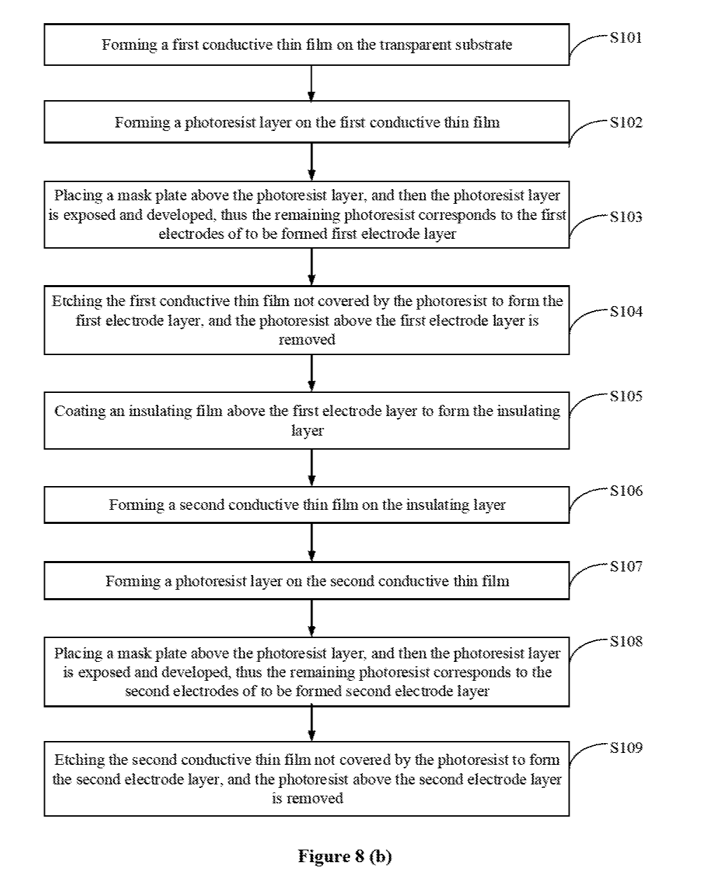

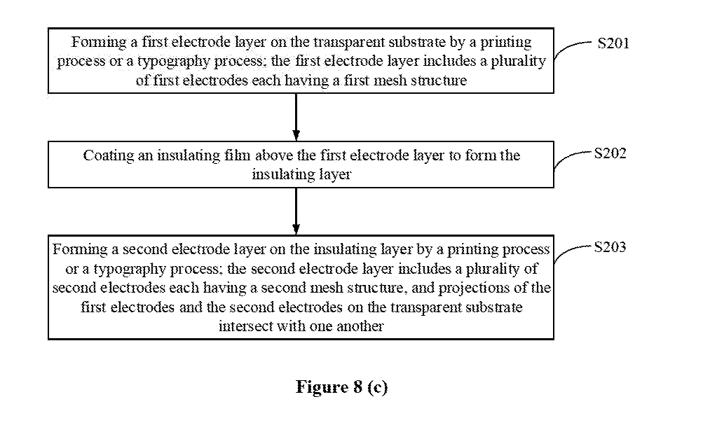

The present disclosure also provides a fabrication method of the touch substrate. Referring to FIG. 8, the fabrication method may include the following steps.

In S10: A first electrode layer may be formed on the transparent substrate 41 by a patterning process. The first electrode layer may include a plurality of first electrodes each having a first mesh structure. Referring to FIGS. 2-4, for example, the first electrodes may be the sensing electrodes 42. In this case, the first electrode layer may be the sensing electrode layer. The patterning process may not be limited to the manner where the mask plate is used for patterning. Other patterning methods, such as printing and typography, may also he used. In other words, in the present disclosure a process capable of forming the first electrode layer may refer to the patterning process.

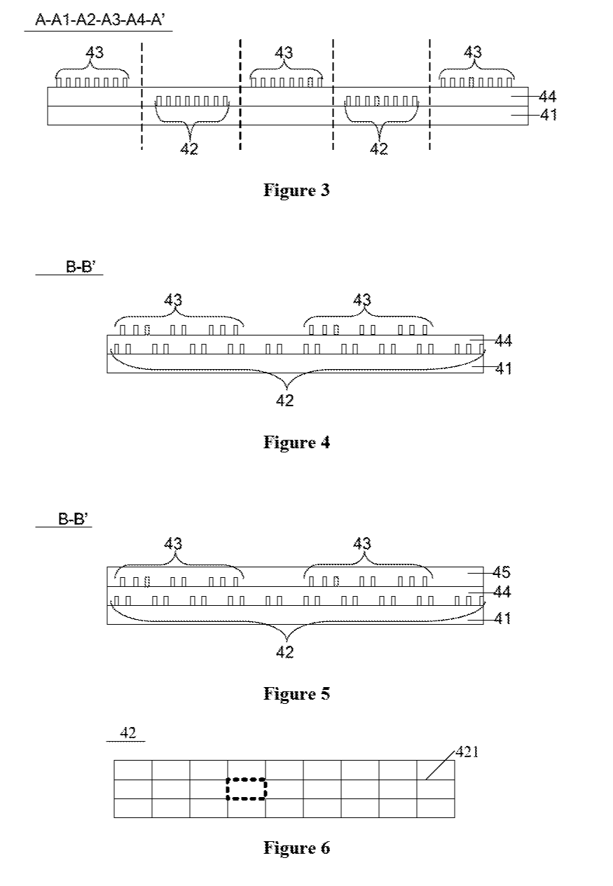

In S11: Referring to FIGS. 3-4, an insulting layer 44 may be formed above the first electrode layer. The insulating layer 44 may be directly formed by a deposition process or a coating process without the need for patterning.

In S12: A second electrode layer may be formed on the insulating layer 44 by a patterning process. The second electrode layer may include a plurality of second electrodes each having a second mesh structure. Projections, e.g., orthographic projections, of the first electrodes and the second electrodes on the transparent substrate may intersect with one another. Referring to FIGS. 2-4, for example, the second electrodes may be the driving electrodes 43. In this case, the second electrode layer may be the driving electrode layer. The patterning process may not be limited to the manner where the mask plate is used for patterning. Other patterning methods, such as printing and typography, may also be used. In other words, in the present disclosure, a process capable of forming the second electrode layer may refer to the patterning process.

Before performing the exemplary step S10, based on differ size of the display device where the touch substrate 40 may be used, optical simulation may be first performed by using a related software, such that, the parameters of the mesh of the sensing electrodes 42 and the driving electrodes 43 may match with the display panel. For example, for a diamond-shaped mesh, appropriate diamond side length and diamond angle may be simulated to avoid an issue of easy occurrence of interference fringes after the mismatched touch substrate 40 is fitted to the display panel. In addition, the first electrode layer and the second electrode layer may be made of a transparent conductive material, such as ITO, or a metal material.

In the fabrication method of the touch substrate consistent with disclosed embodiments, the sensing electrodes 42 and the driving electrodes 43 may be formed on the transparent substrate 41 by two patterning processes, while the insulating layer 44 for isolation may be formed without being etched. Compared to the existing techniques, the number of the patterning processes may be reduced, the fabrication process may be simple and high yield. On this basis, because the sensing electrodes 42 and the driving electrodes 43 may have a mesh structure and may be directly formed on the transparent substrate 41, the transmittance of the touch substrate 40 may be increased and reach approximately 90% or more. In addition, compared to the existing techniques, because there is no bridge, the breakdown phenomenon at the bridge during the ESD process may be avoided, thus the performance of the products may be improved.

Two embodiments are provided below to describe in detail the fabrication method of the touch substrate.

FIG. 8(b) illustrates a flow chart of a fabrication method of the touch substrate consistent with disclosure embodiments. The method may include the following steps.

In S101: A first conductive thin film may be formed on the transparent substrate 41. The first conductive thin film may be formed by a deposition process, a coating process, or a sputtering process, etc.

In S102: A photoresist layer may be formed on the first conductive thin film. The photoresist layer may be formed by a deposition process, or a coating process, etc.

In S103: A mask plate may be placed above the photoresist layer, and then the photoresist layer may be exposed and developed, thus the remaining photoresist may correspond to the first electrodes of the first electrode layer to be formed. Referring to FIGS. 2-4, for example, the first electrodes may be the sensing electrodes 42. In this case, the first electrode layer may be the sensing electrode layer.

In S104: The first conductive thin film not covered by the photoresist may be etched to form the first electrode layer, and the photoresist above the first electrode layer may be removed. The first conductive thin film may be etched by a dry etching process, or a wet etching process.

In S105: Referring to FIGS. 3-4, an insulating film may be coated above the first electrode layer to form the insulating layer 44.

In S106: A second conductive thin film may be formed on the insulating layer 44. The second conductive thin film may be formed by a deposition process, a coating process, or a sputtering process. etc.

In S107: A photoresist layer may be formed on the second conductive thin film. The photoresist layer may be formed by a deposition process, or a coating process, etc.

In S108: A mask plate may be placed above the photoresist layer, and then the photoresist layer may be exposed and developed, thus the remaining photoresist may correspond to the second electrodes of the second electrode layer to be formed. Referring to FIGS. 2-4, for example, the second electrodes may be the driving electrodes 43. In this case, the second electrode layer may be the driving electrode layer.

In S109: The second conductive thin film not covered by the photoresist may be etched to form the second electrode layer, and the photoresist above the second electrode layer may be removed. The second conductive thin film may be etched by a dry etching process, or a wet etching process.

In the present disclosure, the mesh matching accuracy of the formed sensing electrodes 42 and the driving electrodes 43 may be desired by using the conventional patterning process including film formation, exposure, development, etching, and photoresist peeling.

FIG. 8(c) illustrates a flow chart of another fabrication method of the touch substrate consistent with disclosure embodiments. The method may include the following steps.

In S201: A first electrode layer may be formed on the transparent substrate 41 by a printing process or a typography process. The first electrode layer may include a plurality of first electrodes each having a first mesh structure. Referring to FIGS. 2-4, for example, the first electrodes may be the sensing electrodes 42. In this case, the first electrode layer may be the sensing electrode layer.

In S202: Referring to FIGS. 3-4, an insulating film may be coated above the first electrode layer to form the insulating layer 44.

In S203: A second electrode layer may be formed on the insulating layer 44 by a printing process or a typography process. The second electrode layer may include a plurality of second electrodes each having a second mesh structure. Projections of the first electrodes and the second electrodes on the transparent substrate may intersect with one another. Referring to FIGS. 2-4, for example, the second electrodes may be the driving electrodes 43. In this case, the second electrode layer may be the driving electrode layer.

Based on this, the method may also include forming a protection layer 45 above the second electrode layer. In one embodiment, referring to FIG. 5, the second electrode layer may be a driving electrode layer, in other words, the protection layer 45 may be formed above the driving electrodes 43. The protection layer 45 can be directly formed by a deposition process or a coating process without the need for patterning.

In the present disclosure, by forming the protection layer 45 above one of the sensing electrode layer and the driving electrode layer, that is further away from the transparent substrate 41, when the sensing electrode layer or the driving electrode layer, that is formed on the outermost side, is made of a metal material, reduction in the touch performance caused by oxidation and corrosion may be avoided. The protection layer 45 may be made of a same material as the insulating layer 44.

Based on this, a shape of the mesh in the mesh structure may be a regular polygon or an irregular polygon. Referring to dashed boxes in FIG. 2, the shape of the mesh may be rhombic, triangular, or pentagonal, etc. Referring to a dashed box in FIG. 6, the shape of the mesh may be rectangular. In addition, the shape of the mesh may be hexagonal or other regular polygons, or irregular polygons, etc.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A touch substrate, comprising:
a transparent substrate; and
a first electrode layer, an insulating layer, and a second electrode layer, sequentially on the transparent substrate, wherein:
the first electrode layer includes a plurality of first electrodes,
the second electrode layer includes a plurality of second electrodes;
the first electrodes intersect with the second electrodes; and
each of the first electrodes and the second electrodes has a mesh structure.

2. The touch substrate according to claim 1, wherein:
the first electrode is a sensing electrode,
the second electrode is a driving electrode, and
the first electrodes and the second electrodes are made of a metal material.

3. The touch substrate according to claim 2, wherein:
a square resistance of the metal material is smaller than or equal to 0.3Ω/cm².

4. The touch substrate according to claim 2, further including:
a protection layer above the second electrode layer.

5. The touch substrate according to claim 4, wherein:
the protection layer is made of a same material as the insulating layer.

6. The touch substrate according to claim 1, wherein:
a shape of a mesh in the mesh structure is a regular polygon.

7. The touch substrate according to claim 6, wherein:
the insulating layer is made of an inorganic material including at least one of silicon oxide, silicon nitride, and silicon oxynitride.

8. The touch substrate according to claim 1, wherein:
the insulating layer is between the first electrodes and the second electrodes in a direction perpendicular to a surface of the transparent substrate.

9. The touch substrate according to claim 1, wherein:
the first electrodes and the second electrodes are made of Ag (silver), Cu (copper), Al (aluminum), or AlNb (aluminum niobium alloy) alloy.

10. A display device, comprising:
a display panel; and
the touch substrate according to claim 1, on a light exit side of the display panel.

11. The display device according to claim 10, wherein:
the display panel is a liquid crystal display panel; or
the display panel is an organic light emitting diode (OLED) display panel.

12. The display device according to claim 10, wherein:
the display panel is attached to the touch substrate through an optical adhesive.

13. A fabrication method of a touch substrate, comprising:
forming a first electrode layer, on a transparent substrate and including a plurality of first electrodes each having a first mesh structure;
forming an insulting layer on the first electrode layer; and
forming a second electrode layer, on the insulating layer and including a plurality of second electrodes each having a second mesh structure, wherein:
orthographic projections of the first electrodes and the second electrodes on the transparent substrate intersect with one another.

14. The fabrication method according to claim 13, wherein:
one of the first electrode and the second electrode is a driving electrode, and another of the first electrode and the second electrode is a sensing electrode.

15. The fabrication method according to claim 13, further including:
forming a protection layer, above the second electrode layer.

16. The fabrication method according to claim 15, wherein:
the protection layer is made of a same material as the insulating layer.

17. The fabrication method according to claim 13, wherein:
a shape of a mesh in the first and second mesh structures is a regular polygon.

18. The fabrication method according to claim 13, wherein:
the first electrode layer and the second electrode layer are formed by a patterning process, including film formation, exposure, development, etching, and photoresist peeling.

19. The fabrication method according to claim 13, wherein:
the first electrode layer and the second electrode layer are formed by a printing process or a typography process.

20. The fabrication method according to claim 19, wherein:
the insulating layer is formed by a deposition process or a coating process.
